(19) United States
(12) Patent Application Publication
(10) Pub. No.: US 2017/0356180 A1
(43) Pub. Date: Dec. 14, 2017

(54) Air and moisture barrier adhesive membrane and permeable to water vapor

(71) Applicant: ADHEX TECHNOLOGIES, Chenôve (FR)

(72) Inventors: Charles LESIRE, DIJON (FR); Hervé DURAND, DIJON (FR); Roland DE LA BROSSE, DIJON (FR)

(21) Appl. No.: 15/620,985

(22) Filed: Jun. 13, 2017

(30) Foreign Application Priority Data
Jun. 14, 2016 (FR) 1655516

(51) Int. Cl. E04B 1/62; B32B 7/02; B32B 7/14

(52) U.S. Cl. CPC E04B 1/625; B32B 7/14; B32B 7/02; B32B 2307/7242; C09J 2423/006

(57) ABSTRACT

An adhesive membrane is provided which is airproof and moisture-proof and permeable to water vapor, intended for surfaces of buildings, including at least one film (1) permeable to water vapor and a layer of a pressure-sensitive adhesive, the adhesive layer being deposited on one of the faces, a so-called lower face of the film; the membrane includes a first layer (2) of a pressure-sensitive adhesive deposited on the totality of the lower face of the film over a thickness of less than or equal to 50 μm and a second layer (3) of a pressure-sensitive adhesive deposited on the first layer (2) for covering the first layer (2) over 2 to 99% of the surface of the first layer (2) over a thickness comprised between 50 μm and 2 mm.

The present invention relates to an adhesive membrane which is an airproof and moisture-proof barrier permeable to water vapor, intended for surfaces of buildings.

In the field of the construction of buildings, the use of adhesive membranes which are airproof and moisture-proof barriers and permeable to water vapor is well known, said membranes being interposed between the layers of the structural wall of the building in order to avoid problems due to accumulation of moisture.

These membranes generally comprise a membrane permeable to water vapor coated on one side by an adhesive. These membranes also form barriers against air and moisture, the microporous structure of the membranes allowing the passing of water vapor while preventing the passing of air.

Indeed, the molecular structure of water vapor allows it to pass through smaller pores than oxygen and nitrogen notably.

Said membranes are attached on the walls of the building by means of the adhesive layer, usually a pressure-sensitive adhesive with an overlap of two adjacent membranes in order to ensure a seal.

Such membranes are notably described in documents U.S. Pat. No. 5,895,301 and U.S. Pat. No. 6,901,712.

Document U.S. Pat. No. 5,895,301 describes a laminated barrier which may be torn by hand, intended to obturate an interstice or a joint in a construction comprising a reinforcement mast having a first resistance to traction, a plain flexible cellulose strip at the reinforcement mast, which may be penetrated by liquids in its untreated state, and having a second resistance to traction which is less than the first resistance to traction, a water-resistant polymeric resin applied on the strip in order to make it resistant to liquid water while allowing water vapor to cross it. The reinforcement mast contains polyester, rayon, glass fibres or a combination of these fibres and the polymeric resin infiltrates the strip in order to reduce the dimensions of the pores of the latter in order to practically prevent the passing of liquid water.

This type of membrane has the drawback of being expensive to produce and of not providing laterally a perfect seal to air.

Document U.S. Pat. No. 6,901,712 as for it describes an adhesive membrane which is airproof and moisture-proof and permeable to water vapor intended for structural surfaces of buildings and which lets through water vapor. Said membrane consists of a sheet permeable to water vapor, on a surface of which is applied a discontinuous adhesive film.

Although this type of membrane has the advantage of providing laterally a good seal to air, it nevertheless has the drawback of being expensive to produce.

One of the objects of the invention is therefore to find a remedy to these drawbacks by proposing an adhesive membrane which is airproof and moisture-proof and permeable to water vapor, intended for surfaces of buildings, of a simple and inexpensive design, providing good adhesion on the walls of the building and a good seal to air laterally.

For this purpose and according to the invention, an adhesive membrane which is airproof and moisture-proof and permeable to water vapor is proposed, intended for surfaces of buildings, including at least one film permeable to water vapor and a layer of a pressure-sensitive adhesive, said adhesive layer being deposited on one of the faces a so-called lower face of the film; said membrane is remarkable in that it includes a first layer of a pressure-sensitive adhesive deposited on the totality of the lower face of the film over a thickness of less than or equal to 50 μm and a second layer of a pressure-sensitive adhesive deposited on said first layer for covering the first layer over 2 to 99% of the surface of the first layer over a thickness comprised between 50 μm and 2 mm.

Preferably, the ratio between the permeability of said membrane and the permeability of the film permeable to water vapor is comprised between 0.70 and 0.99 and, preferably comprised between 0.8 and 0.9, said permeability being measured according to the ASTM E96 standard method A.

Said first pressure-sensitive adhesive layer is obtained in a hot melt adhesive.

Moreover, said second pressure-sensitive adhesive layer is obtained in a hot melt adhesive, said hot melt adhesive being able to be identical or different from the hot melt adhesive of the first layer.

According to an alternative embodiment, the second pressure-sensitive adhesive layer is deposited as horizontal and/or vertical and/or diagonal strips.

According to another preferred embodiment alternative, the second pressure-sensitive adhesive layer is deposited as horizontal and/or vertical and/or diagonal cords.

Preferably, the second pressure-sensitive adhesive layer is deposited as diagonal cords for forming cross-pieces.

Further, the film includes at least one microporous film or a composite of the latter and/or at least one oriented polymeric film or a composite of the latter and/or at least one polyolefin film or a composite of the latter and/or at least one polypropylene film or a composite of the latter and/or at least one non-woven polyolefin film or a composite of the latter.

Accessorily, the membrane according to the invention includes a protective film capping the second pressure-sensitive adhesive layer.

Other advantages and characteristics will better emerge from the description which will follow, of a single embodiment alternative, given as a non-limiting example, of the adhesive membrane which is airproof and moisture-proof and permeable to water vapor according to the invention, from the appended drawings wherein:

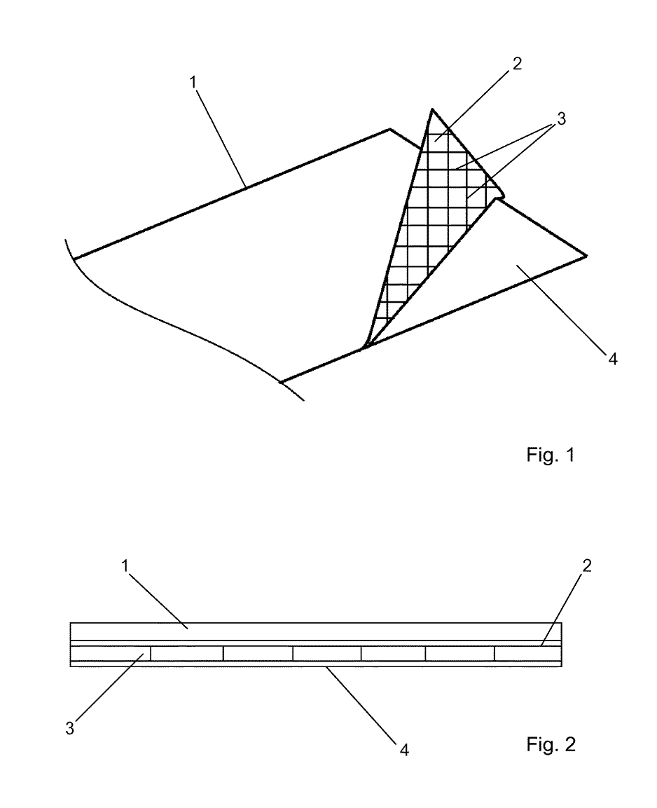

FIG. 1 is a perspective view of an adhesive membrane airproof and moisture-proof and permeable to water vapor according to the invention,

FIG. 2 is an elevational view of an adhesive membrane which is airproof and moisture-proof and permeable to water vapor according to the invention,

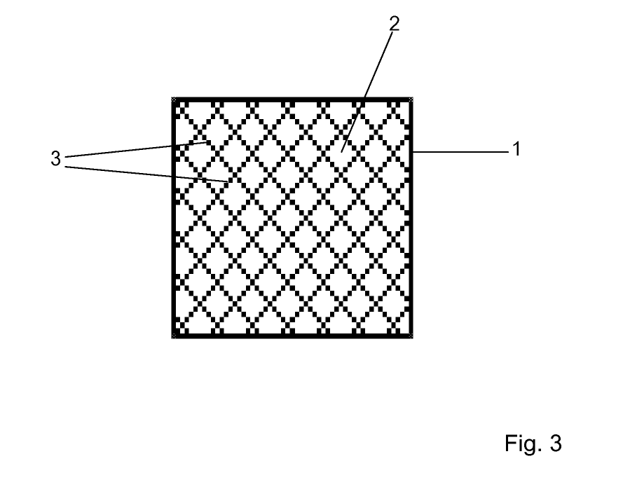

FIG. 3 is a bottom view of an adhesive membrane which is airproof and moisture-proof and permeable to water vapor according to the invention.

With reference to FIGS. 1 to 3, the adhesive membrane which is airproof and moisture-proof and permeable to water vapor, intended for surfaces of buildings, according to the invention, consists of a film permeable to water vapor 1, of a first layer 2 of a pressure-sensitive adhesive deposited on the totality of the lower face of the film 1 over a thickness less than or equal to 50 μm, with a basis weight comprised between 10 and 80 g/m², and preferably a basis weight comprised between 10 and 20 g/m², and of a second layer 3 of a pressure-sensitive adhesive deposited on said first layer 2 for covering the first layer over 2 to 99% of the surface of the first layer over a thickness comprised between 50 μm and 2 mm, with a basis weight comprised between 60 and 180 g/m², and preferably a basis weight comprised between 100 and 140 g/m².

Said film 1 may consist in any barrier film well known to one skilled in the art and may for example include at least one microporous film or a composite of the latter and/or at least one oriented polymeric film or a composite of the latter and/or at least one polyolefin film or a composite of the latter and/or at least one polypropylene film or a composite of the latter and/or at least one non-woven polyolefin film or a composite of the latter.

Moreover, said first layer 2 of a pressure-sensitive adhesive is obtained in a hot melt adhesive and said second layer 3 of a pressure-sensitive adhesive is also obtained in a hot melt adhesive, said hot melt adhesive being able to be identical with or different from the hot melt adhesive of the first layer.

However, it is quite obvious that the pressure-sensitive adhesive of the first 2 and second 3 layers may consist in any pressure-sensitive adhesive well known to one skilled in the art. Such adhesives may for example consist in acrylate adhesives without however departing from the scope of the invention.

Preferably, with reference to FIGS. 1 and 3, the second pressure-sensitive adhesive layer 3 is deposited as diagonal cords for forming cross-pieces. It will be noted that the cross-pieces of the second pressure-sensitive adhesive layer 3 provides a good seal to air laterally and that the first pressure-sensitive adhesive layer 2 improves the strength of the membrane by allowing adhesion with the wall on which is attached the membrane between the cords of the second layer 3.

Further, it will be observed that the small thickness of the first pressure-sensitive adhesive layer 2 only provides a small decrease in the permeability of the film 1 which is not detrimental to the performance of the membrane. Preferably, the pressure-sensitive adhesives, their basis weights per unit surface and the thickness of the adhesive layers are selected so that the ratio between the permeability of the membrane according to the invention and the permeability of the film (without any adhesive layers) is comprised between 0.70 and 0.99 and preferably, comprised between 0.80 and 0.90.

### EXAMPLE 1

An adhesive membrane which is airproof and moisture-proof according to the invention was made from a film permeable to water vapor 1 consisting of a three-layer non-woven film marketed under the reference Stratec® II by SOPREMA, of a first layer 2 of a pressure-sensitive adhesive of the hot melt type marketed under reference AC Resin 260UV by BASF deposited on the totality of the lower face of the film 1 over a thickness of less than 50 μm, with a basis weight of 14 g/m² and of a second layer 3 of a pressure-sensitive adhesive marketed under reference TLH 2901 by Bostik deposited on said first layer 2 as cross-pieces for covering the first layer over 18% of the surface of the first layer over a thickness greater than 50 μm and with a basis weight of 102 g/m².

The three-layer non-woven film marketed under reference Stratec® II by SOPREMA and forming the film permeable to water vapor 1 has a permeability of 48.5 according to the ASTM E96 standard.

### EXAMPLE 2

An adhesive membrane both airproof and moisture-proof according to the invention was made from a film pervious to water vapor 1 consisting of a three-layer non-woven film marketed under the reference Stratec® II by SOPREMA, of a first layer 2 of a pressure-sensitive adhesive of the hot melt type marketed under reference AC Resin 260UV by BASF deposited on the totality of the lower face of the film 1 over a thickness of less than 50 μm, with a basis weight of 14 g/m² and of a second layer 3 of a pressure-sensitive adhesive marketed under reference TLH 2901 by Bostik deposited on said first layer 2 as cross-pieces for covering the first layer on 21% of the surface of the first layer over a thickness of more than 50 μm and with a basis weight of 140 g/m².

Table 1 below illustrates the breathability results for Examples 1 and 2 as compared with the breathability of the three-layer non-woven film marketed under reference Stratec® II by SOPREMA. It will be noted that the breathability is measured according to the ASTM E96 standard method A.

| | 1^{st} adhesive | 2^{nd} adhesive | Permanent |
|---|---|---|---|
| | layer - basis | layer - basis | breathability |
| | weight (g/m²) | weight (g/m²) | ASTM E96 |
| Stratec 2 | — | — | 48.5 |
| Example 1 | 14 | 102 | 42.6 |
| Example 2 | 14 | 140 | 39.6 |

As this may be ascertained in table 1, the low basis weight, i.e. the small thickness, of the first layer 2 of pressure-sensitive adhesive only provides a small decrease in the permeability of the film 1, without any adhesive layers, which is not detrimental to the performance of the membrane. Thus, it appears that the decrease in the permeability is only 18% for Example 1 and only 21% for Example 2 based on the permeability of the film 1 without any adhesive layers. The ratio between the permeability of the membrane according to the invention and the permeability of the film (without any adhesive layers) is 0.88 for Example 1 and 0.82 for Example 2.

Table 2 below is a comparison of the breathability of the membranes marketed by Henry under reference BlueSkin VP100, and corresponding to the American patent U.S. Pat. No. 6,901,712, with the Examples 1 and 2 described earlier.

| | 1^{st} adhesive | 2^{nd} adhesive | Permanent |
|---|---|---|---|
| | layer - basis | layer - basis | breathability |
| | weight (g/m²) | weight (g/m²) | ASTM E96 |
| BlueSkin | 136 | — | 33 |
| VP100 | | | |
| Example 1 | 14 | 102 | 42.6 |
| Example 2 | 14 | 140 | 39.6 |

It clearly appears that the breathability of Examples 1 and 2 of the membrane according to the invention is clearly greater than that of the products of the prior art.

According to an alternative embodiment, the second layer of pressure-sensitive adhesive may be deposited as horizontal and/or vertical and/or diagonal strips or further as horizontal and/or vertical and/or diagonal cords, said strips and/or said cords may be rectilinear or sinuous, in order to form regular or irregular patterns, without however departing from the scope of the invention.

Accessorily, with reference to FIGS. 1 and 2, the membrane according to the invention includes a protective film 4 capping the second layer 3 of pressure-sensitive adhesive. Said protective film 4 consists in any protective film well known to one skilled in the art such as a film including a silicone surface for example.

It is quite understood that the present invention is by no means limited to the embodiments described above and that many modifications may be provided thereto without departing from the scope of the appended claims.

1. An adhesive membrane which is airproof and moisture-proof and permeable to water vapor, intended for surfaces of buildings, including at least one film (1) permeable to water vapor and a layer of a pressure-sensitive adhesive, said adhesive layer being deposited on one of the faces a so-called lower face of the film, characterized in that it includes a first layer (2) of a pressure-sensitive adhesive deposited on the totality of the lower face of the film (1) over a thickness of less than or equal to 50 μm and a second layer (3) of a pressure-sensitive adhesive deposited on said first layer (2) for covering the first layer (2) over 2 to 99% of the surface of the first layer (2) over a thickness comprised between 50 μm and 2 mm.

2. The membrane according to claim 1 characterized in that the ratio between the permeability of said membrane and the permeability of the film (1) permeable to water vapor is comprised between 0.70 and 0.99 and preferably, comprised between 0.8 and 0.9, said permeability being measured according to the ASTM E96 standard method A.

3. The membrane according to claim 1 characterized in that first layer (2) of a pressure-sensitive adhesive is obtained in a hot melt adhesive.

4. The membrane according to claim 1 characterized in that the second layer (3) of a pressure-sensitive adhesive is obtained in a hot melt adhesive.

5. The membrane according to claim 1 characterized in that the second layer (3) of a pressure-sensitive adhesive is deposited as horizontal and/or vertical and/or diagonal strips.

6. The membrane according to claim 1 characterized in that the second layer (3) of a pressure-sensitive adhesive is deposited as horizontal and/or vertical and/or diagonal cords.

7. The membrane according to claim 6 characterized in that the second layer (3) of a pressure-sensitive adhesive is deposited as diagonal cords in order to form cross-pieces.

8. The membrane according to claim 1, characterized in that the film (1) includes at least one microporous film or a composite of the latter.

9. The membrane according to claim 1, characterized in that the film (1) includes at least one oriented polymeric film or a composite of the latter.

10. The membrane according to claim 1 characterized in that the film (1) includes at least one polyolefin film or a composite of the latter.

11. The membrane according to claim 1 characterized in that the film (1) includes at least one polypropylene film or a composite of the latter.

12. The membrane according to claim 1 characterized in that the film (1) includes at least one film in non-woven polyolefin or a composite of the latter.

13. The membrane according to claim 1 characterized in that it includes a protective film (4) capping the second layer of pressure-sensitive adhesive.
